(19) United States
(12) Patent Application Publication
(10) Pub. No.: US 2026/0307589 A1
(43) Pub. Date: Oct. 8, 2026

(54) ENCLOSURE SYSTEM FOR A VEHICULAR LADDER RACK

(71) Applicant: Danny Brandon, Manchester, TN (US)

(72) Inventor: Danny Brandon, Manchester, TN (US)

(21) Appl. No.: 19/638,508

(22) Filed: Apr. 3, 2026

Related U.S. Application Data
(60) Provisional application No. 63/782,684, filed on Apr. 3, 2025.

(51) Int. Cl. B60R 9/048; B60R 9/042

(52) U.S. Cl. CPC B60R 9/0485; B60R 9/0423

(57) ABSTRACT

A vehicular ladder protection system for a ladder rack having a stationary support and an operable support that moves between storage and loading positions. The ladder protection system includes a ladder cover having a cover frame and a protecting member that defines a ladder receptacle in a covering position. The ladder protection system also includes a lever that is attached to a pivot rod where the operable support rotationally engages the stationary support. The lever operates the pivot rod to move the operable support between the storage and loading positions. The ladder protection system also includes a linkage that extends between the pivot rod and a base of the ladder cover. The linkage operates with the pivot rod to operate the ladder cover between the covering position and a bypass position that allows the operable support to the loading position.

### CROSS-REFERENCE TO RELATED APPLICATION

This application claims priority to and the benefit under 35 U.S.C. § 119(e) of U.S. Provisional Patent Application No. 63/782,684, filed on Apr. 3, 2025, entitled ENCLOSURE SYSTEM FOR A VEHICULAR LADDER RACK, the entire disclosure of which is hereby incorporated herein by reference.

### FIELD OF THE DISCLOSURE

The present disclosure generally relates to ladder racks for vehicles and, more specifically, an enclosure system for a vehicular ladder rack that protects ladders from degradation due to exposure to solar radiation and other elements.

### BACKGROUND OF THE DISCLOSURE

Ladders are utilized by contractors, utility workers, laborers, and other individuals during the course of their work. Frequently, it is necessary that these individuals transport ladders to and from a worksite. To transport these ladders, vehicles can be equipped with a rack for storing and transporting ladders between uses. Certain ladder racks can include operable portions that assist in loading and unloading a ladder with respect to the ladder rack and the vehicle.

### SUMMARY OF THE DISCLOSURE

According to an aspect of the present disclosure, a ladder protection system for a vehicular ladder rack is disclosed. The vehicular ladder rack has a stationary support that is attached to a vehicle and an operable support that is coupled with the stationary support and movable relative to the stationary support between a storage position and a loading position. The ladder protection system includes a ladder cover having a cover frame and a protecting member that defines a ladder receptacle with the ladder cover in a covering position and said operable support in said storage position. The ladder protection system also includes a lever that is attached to a pivot rod that is defined where the operable support rotationally engages the stationary support. The lever is rotationally operable to rotate the pivot rod, and to move the operable support between the storage position and the loading position. The ladder protection system also includes a linkage that extends between the pivot rod and a base of the ladder cover. The linkage operates with the pivot rod to operate the ladder cover between the covering position that defines the ladder receptacle, and a bypass position that allows the operable support to move away from the ladder cover and to the loading position.

According to another aspect, a ladder protection system for a vehicular ladder rack is disclosed. The vehicular ladder rack has a stationary support that is attached to a vehicle and an operable support that is coupled with the stationary support and movable relative to the stationary support between a storage position and a loading position. The ladder protection system includes a ladder cover that is operable between a covering position and a bypass position, where the covering position is configured to extend over said operable support in said storage position, and the bypass position is configured to be rotated away from said stationary support to permit rotation of said operable support between said storage position and said loading position. The ladder protection system also includes a lever coupled with each of said operable support and the ladder cover via a pivot rod, where operation of the pivot rod operates said operable support between said storage position and said loading position. The ladder protection system further includes a linkage that extends between the pivot rod and a linkage portion of the ladder cover, where the linkage operates with the pivot rod and the linkage portion to operate the ladder cover between the covering position and the bypass position.

According to yet another aspect, a ladder protection system for a vehicular ladder rack is disclosed. The vehicular ladder rack has a stationary support that is attached to a vehicle and an operable support that is coupled with the stationary support and movable relative to the stationary support between a storage position and a loading position. The ladder protection system includes a ladder cover that is operable between a covering position that defines a ladder receptacle for extending over said operable support in said storage position and a bypass position that is configured to be distal from the stationary support to permit rotation of said operable support between said storage position and said loading position. The ladder protection system also includes a linkage that is coupled with a lever and a linkage portion of the ladder cover. In the event that the lever is rotated, the linkage operates with a frame pivot of the linkage portion to operate the ladder cover between the covering position and the bypass position. Operation of the lever is further configured to contemporaneously operate said operable support between said storage position and said loading position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of an aspect of a ladder rack shown in a storage position;

FIG. 2 is a perspective view of a ladder rack of FIG. 1, with the ladder rack in the loading position;

FIG. 3 is an aspect of the ladder protection system that includes a linkage coupled with the outer ladder channel and showing the ladder rack in the storage position;

FIG. 4 is a cross-sectional view of the ladder protection system of FIG. 3 and showing the ladder rack moving from the storage position toward the loading position, which operates the linkage for moving the outer ladder channel away from the ladder rack;

FIG. 5 is a cross-sectional view of an aspect of the outer ladder channel and showing a rectangular configuration that includes a brush for assisting in enclosing the ladder within the ladder protection system;

FIG. 6 is a perspective view of an aspect of the outer ladder channel and showing rounded end caps that partially encircle a portion of a ladder contained within the ladder protection system;

FIG. 7 is a cross-sectional view of the outer ladder channel of FIG. 6, taken along line VII-VII;

FIG. 8 is a top perspective view of an aspect of the ladder protection system for a vehicular ladder rack;

FIG. 9 is a side perspective view of the ladder protection system of FIG. 8;

FIG. 10 is a schematic side elevation view of the ladder protection system of FIG. 8, shown with a ladder placed within the operable support and the ladder rack installed on a vehicle;

FIG. 11 is a schematic side elevation view of an aspect of the ladder protection system of FIG. 10, and shown moving from a storage position toward a loading position;

FIG. 12 is a schematic side elevation view of an aspect of the ladder protection system of FIG. 11, and showing the ladder protection system moving toward a bypass position;

FIG. 13 is a schematic side elevation view of an aspect of the ladder protection system of FIG. 12, and showing the ladder protection system in the bypass position;

FIG. 14 is a schematic side elevation view of an aspect of the ladder protection system of FIG. 13, and showing the ladder protection system moving toward the loading position; and

FIG. 15 is a schematic side elevation view of an aspect of the ladder protection system of FIG. 14, and showing the ladder protection system in the loading position.

The components in the figures are not necessarily drawn to scale, emphasis being placed upon illustrating the principles described herein.

### DETAILED DESCRIPTION

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

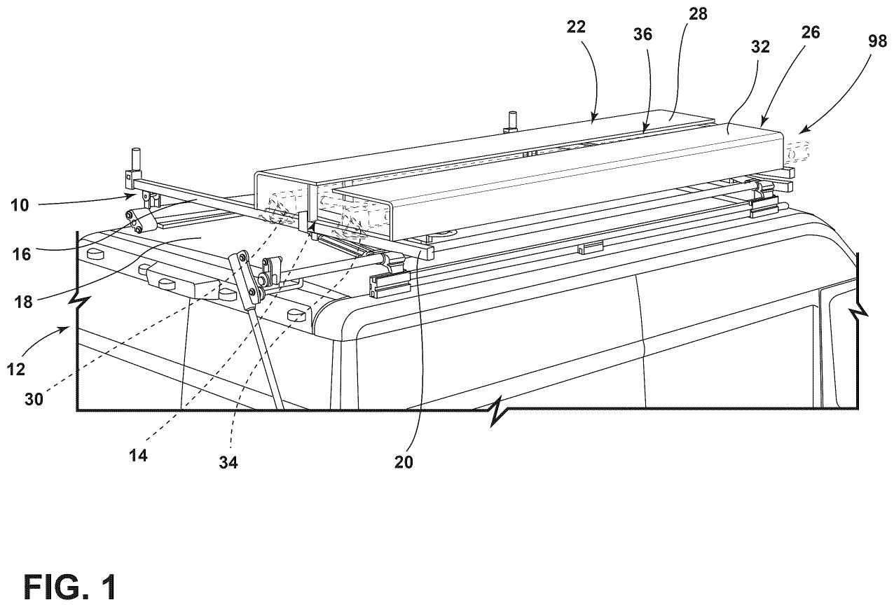

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a ladder protection system for use with a vehicular ladder rack. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises. a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

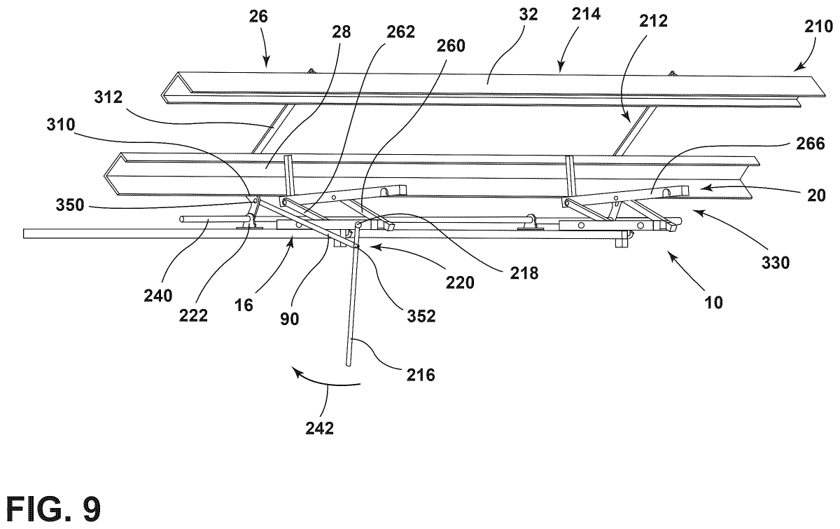

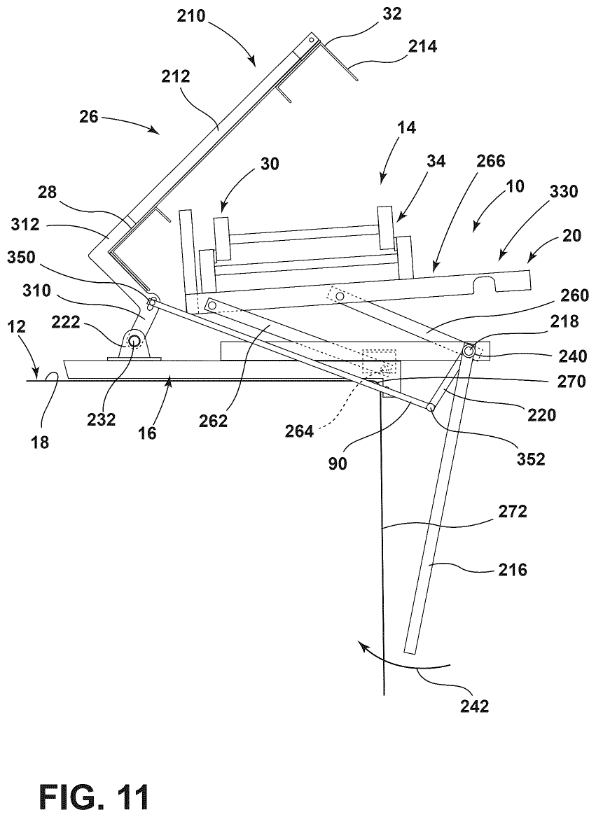

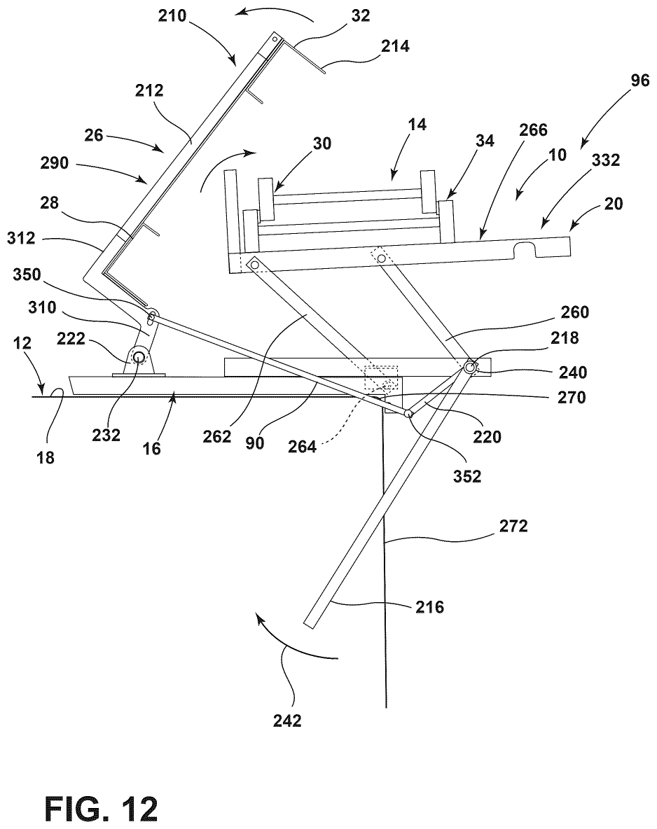

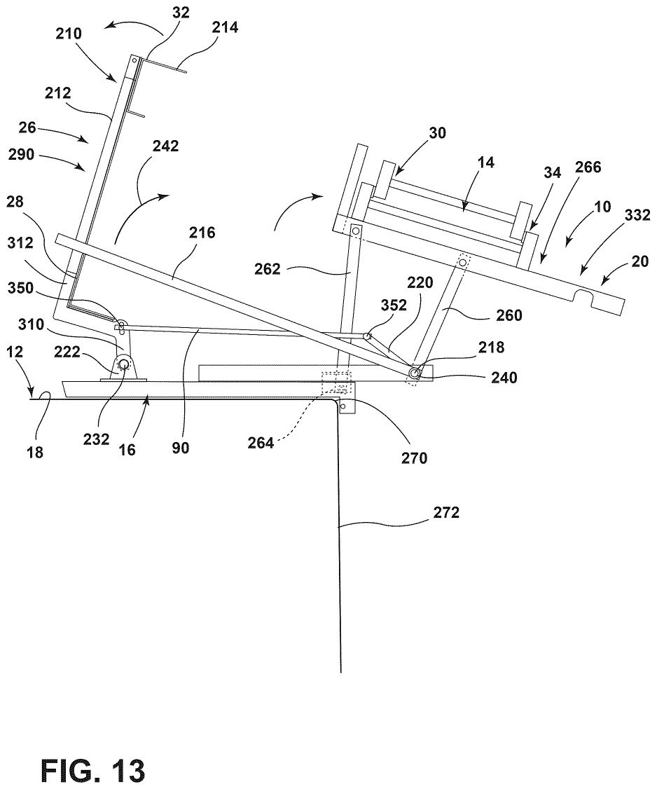

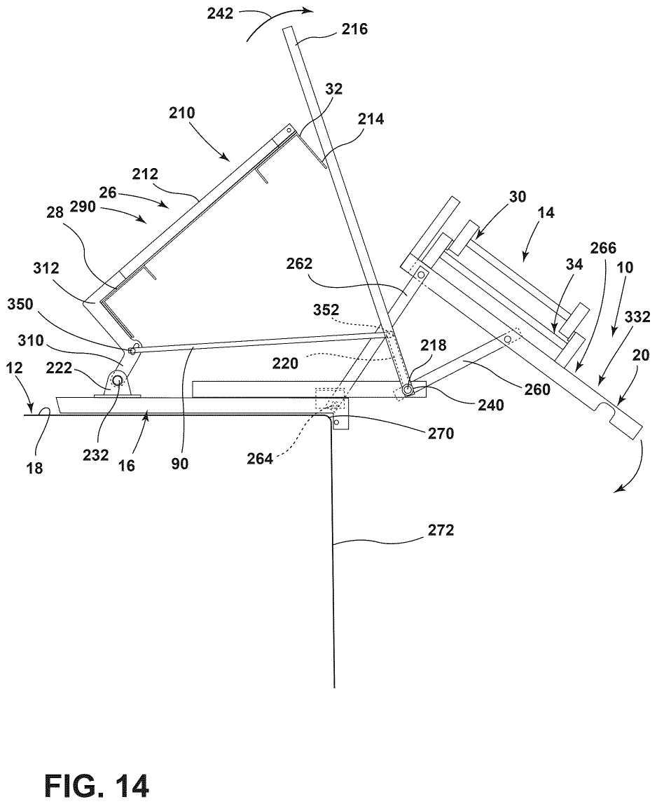

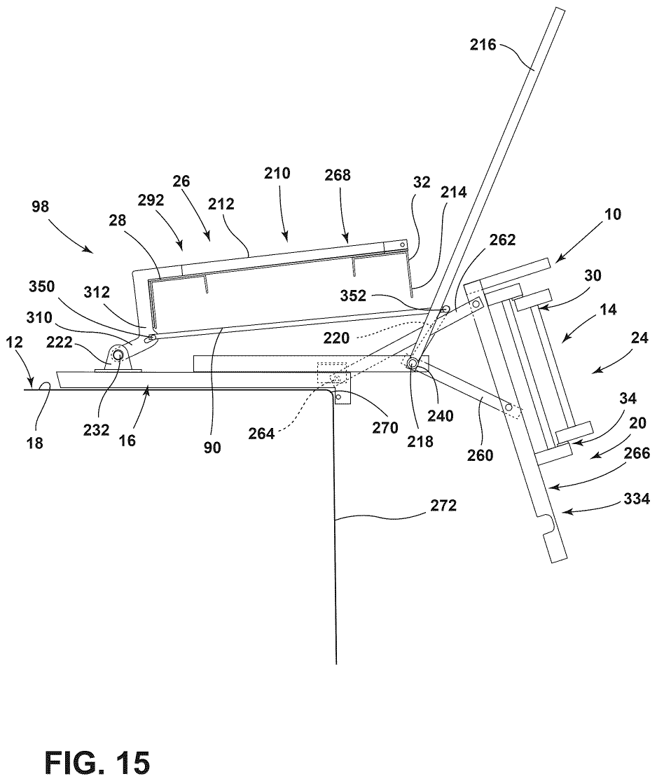

Referring to FIGS. 1-15, reference numeral 10 generally refers to a ladder rack that can be installed on a vehicle 12 for receiving a ladder 14. The ladder rack 10 provides for storage of a ladder 14 during transport from one location to another. In order to load and unload the ladder 14 onto the ladder rack 10, the ladder rack 10 can include a stationary support 16 that is located in a fixed position relative to a roof 18 of the vehicle 12, and an operable support 20 that is coupled with the stationary support 16, and movable relative to the vehicle 12 between a storage position 22 and a loading position 24.

According to the various aspects of the device, as exemplified in FIGS. 1-15, an aspect of the ladder protection system 26 can be attached to the ladder rack 10 for the vehicle 12. The ladder protection system 26 includes an inner ladder channel 28 that is attached to the stationary support 16. The inner ladder channel 28 provides a space that at least partially encircles or surrounds a first side 30 of the ladder 14, when the ladder 14 and the ladder rack 10 are in the storage position 22. The ladder protection system 26 also includes an outer ladder channel 32 that is coupled with the operable support 20. The outer ladder channel 32 cooperates with the inner ladder channel 28 in the storage position 22 to define a ladder receptacle 36. This ladder receptacle 36 protects the first side 30 of the ladder 14 and a second side 34 of the ladder 14, as described herein. The outer ladder channel 32 and the ladder 14 move away from the inner ladder channel 28 as the operable support 20 is moved from the storage position 22 to the loading position 24 of the ladder rack 10. In the loading position 24, the ladder 14 is able to be separated from the outer ladder channel 32. Additionally, in the loading position 24, the outer ladder channel 32 provides for access to the second side 34 of the ladder 14 so that the ladder 14 can be loaded and unloaded relative to the operable support 20 of the ladder rack 10.

Referring again to FIGS. 1-15, the ladder 14 is disposed in the ladder rack 10 during transport from one location to another. During this time, the ladder 14 is typically exposed to the elements. Certain ladders 14, typically ladders made of fiberglass, can degrade after extended exposure to solar radiation and other elements. This degradation of the ladder 14 can compromise the structure of the ladder 14, thereby requiring repair and/or replacement of components of ladder 14. The ladder protection system 26 described herein provides the inner ladder channel 28 and the outer ladder channel 32 which cover the first side 30 and the second side 34 of the ladder 14 to prevent solar radiation from reaching the fiberglass components of the ladder 14. Through use of the ladder protection system 26, the lifespan of the ladder 14 can be increased and degradation of the components of the ladder 14 can be prevented, while the ladder 14 is stored within the ladder rack 10.

In certain aspects of the device, the outer ladder channel 32 can be separable from portions of the operable support 20 for the ladder rack 10 such that the outer ladder channel 32 can be partially or fully removed from the operable support 20. Through this configuration, the outer ladder channel 32 can be manipulated to provide access to the second side 34 of the ladder 14 relative to the ladder rack 10.

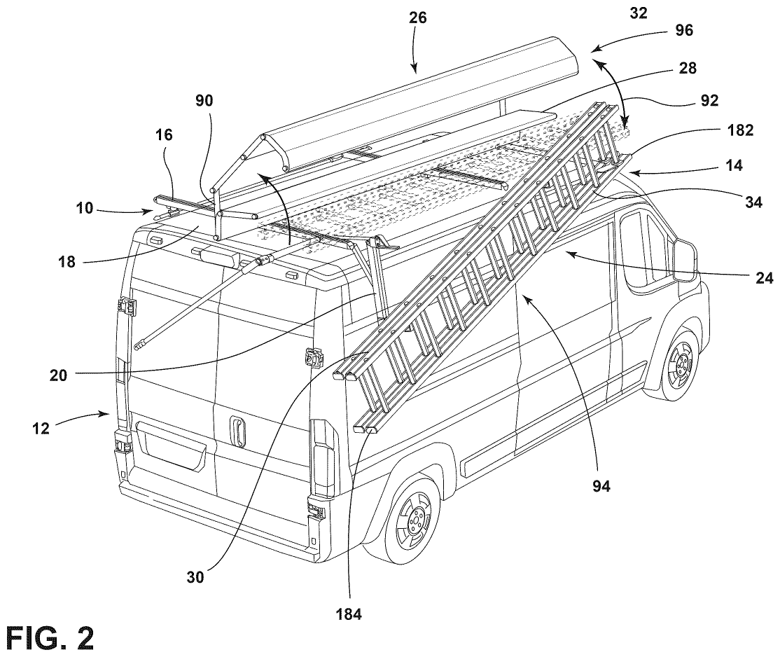

Referring now to FIGS. 2-4 and 8-15, the outer ladder channel 32 can include a linkage 90 that couples the outer ladder channel 32 to the operable support 20 and/or the stationary support 16 of the vehicle ladder rack 10. In the event that the operable support 20 is moved from the storage position 22 to the loading position 24, the linkage 90 operates, in a cooperative manner, to define a path of travel 92 for the outer ladder channel 32. This path of travel 92 for the outer ladder channel 32 is different from a path of motion 94 of the operable support 20 for the vehicle ladder rack 10. Stated differently, as the operable support 20 of the ladder rack 10 is moved in a lateral direction, the linkage 90 coupled with the outer ladder channel 32 can move, typically in an upward rotational direction, to a bypass position 96. In this bypass position 96, the operable support 20 of the ladder rack 10 is able to move laterally and under the outer ladder channel 32 toward the loading position 24 of the ladder rack 10. Similarly, when the operable support 20 of the ladder rack 10 is returned to the storage position 22, the operable support 20 of the ladder rack 10 cooperates with the linkage 90 to return the outer ladder channel 32 from the bypass position 96 to a covering position 98 relative to the second side 34 of the ladder 14 and the operable support 20 for the ladder rack 10.

Referring again to FIGS. 2-4 and 8-15, the linkage 90 for the ladder protection system 26 typically includes a fixed connection 120 that is attached to the stationary support 16 of the ladder rack 10. Additionally, the linkage 90 can include an operable feature 122 that is attached to and cooperates with the operable support 20 for the ladder rack 10. As the operable support 20 for the ladder rack 10 moves between the storage position 22 and loading position 24, the operable feature 122 of the linkage 90 cooperates with the operable support 20 to manipulate the outer ladder channel 32 between the covering position 98 and the bypass position 96. According to the various aspects of the device, the linkage 90 can be in the form of a rigid bar, a cable system, a multi-part linkage, a counterbalance system, and other similar linkages.

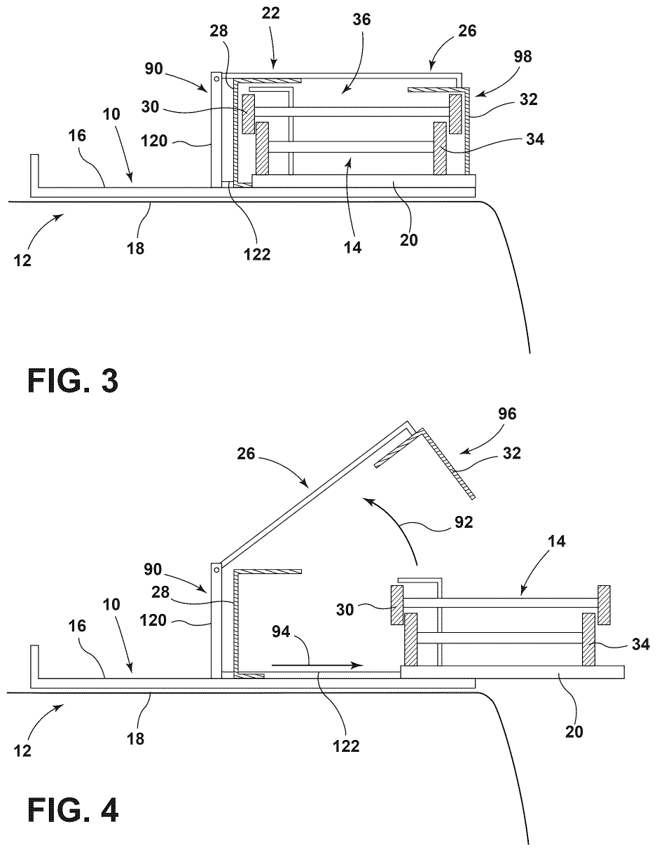

Referring again to FIGS. 3 and 4, the path of travel 92 of the linkage 90 and the outer ladder channel 32 is typically in a rotational path relative to a particular hinge point. It is also contemplated that this path of travel 92 can be linear, circular, a complex motion having linear and circular components, combinations thereof, and other similar paths of travel. It should be understood that the particular path of travel 92 of the outer ladder channel 32 is typically dictated by the configuration of the linkage 90 that is attached to the outer ladder channel 32.

In each of the various configurations of the linkage 90, the outer ladder channel 32 is manipulated to the bypass position 96, which is above the second side 34 of the ladder 14. In this position, the operable support 20 for the ladder rack 10 is able to move in a lateral direction toward the loading position 24.

When the operable support 20 is moved from the loading position 24 back to the storage position 22, the linkage 90 moves the outer ladder channel 32 from the bypass position 96 to the covering position 98. The covering position 98 is typically synonymous with the storage position 22 of the ladder rack 10. In the storage position 22, the outer ladder channel 32 is positioned in close engagement with the second side 34 of ladder 14 to protect ladder 14 from exposure to solar radiation.

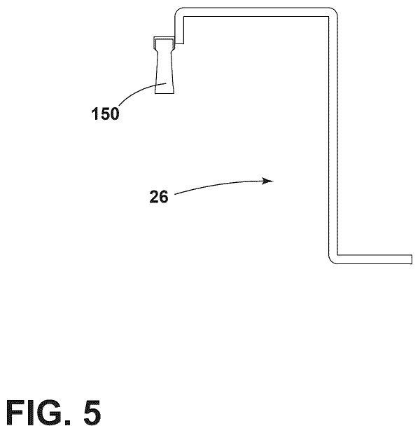

Referring now to FIGS. 5-7, as applied to each of the aspects of the ladder protection system, as illustrated in FIGS. 1-4 and 8-15, the inner ladder channel 28 and the outer ladder channel 32 can each include a brush 150, wiper, or other similar flexible member that assists in covering the first side 30 and the second side 34 of the ladder 14. This brush 150 typically extends downward to at least partially surround the first side 30 and the second side 34 of ladder 14. Through this configuration, the brush 150 provides additional coverage for the ladder protection system 26 in preventing the elements, including solar radiation, from reaching the surface of the ladder 14. When the operable support 20 for the ladder 14 is moved between the storage position 22 and the loading position 24, the brush 150 is able to deflect to allow portions of the ladder 14 to pass by the brush 150 as the ladder 14 is moved to the loading position 24. The brush 150 is configured to be a generally resilient member that returns to a particular position after repeated uses. The brush 150 can also be used to dislodge debris that may be present on the surface of the ladder 14.

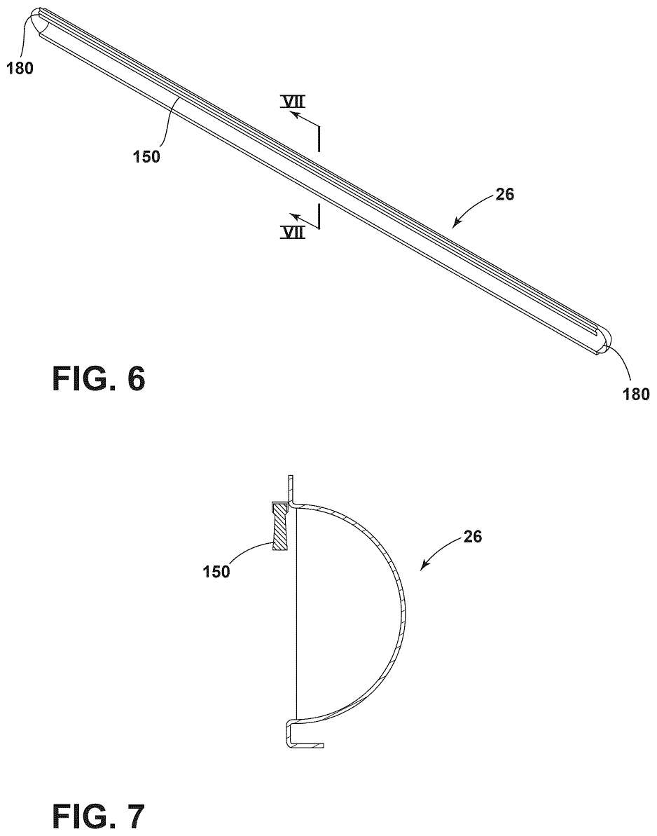

As exemplified in FIGS. 6 and 7, the inner ladder channel 28 and the outer ladder channel 32 can include end caps 180 that can surround end portions of the first side 30 or the second side 34 of the ladder 14. These end caps 180 can be dome shaped, rectilinear, or have other similar configurations. These end caps 180 are used to protect the top edge 182 and bottom edge 184 of the ladder 14 when the ladder 14 is in the storage position 22 within the ladder rack 10.

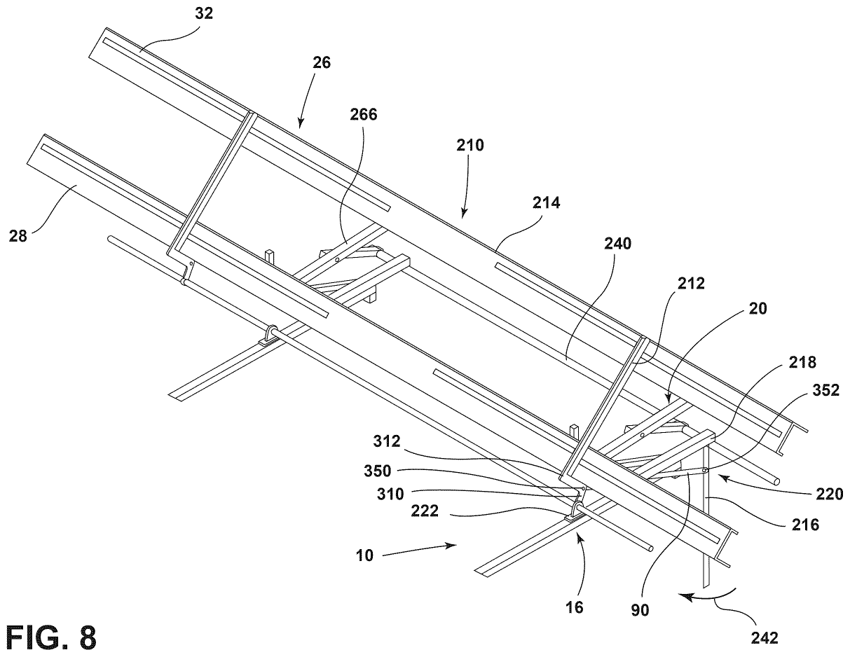

Referring now to FIGS. 8-15, the ladder protection system 26 for the vehicular ladder rack 10 includes the stationary support 16 that is attached to the vehicle 12 and the operable support 20 that is coupled with the stationary support 16. The operable support 20 moves relative to the stationary support 16 between the storage position 22 and the loading position 24. The ladder protection system 26 includes a ladder cover 210 that includes a cover frame 212 coupled with the stationary support 16. The ladder cover 210 also includes a protecting member 214 that defines a ladder receptacle 36 when the ladder cover 210 is in the storage position 22. The ladder protection system 26 includes a lever 216 that is attached to an pivot rod 218. The pivot rod 218 also defines a rotational connection point between the operable support 20 and the stationary support 16. The lever 216 is rotationally operable to rotate the pivot rod 218. This rotation of the pivot rod 218 moves the operable support 20 between the storage position 22 and the loading position 24, and contemporaneously moves the ladder cover 210 between the covering position 98 and the bypass position 96. As described herein, the operable support 20 rotationally engages the stationary support 16 at the pivot rod 218. A rigid linkage 90 extends between a pivot arm 220 of the pivot rod 218 and a base 222 of the stationary support 16. The linkage 90 operates with the pivot rod 218 to operate the ladder cover 210 about a base pivot 232 of the base 222 and between the covering position 98, which defines the ladder receptacle 36, and a bypass position 96 that permits the operable support 20 to move away from the ladder cover 210 and between the loading position 24 and the storage position 22.

The pivot rod 218 and the base pivot 232 of the base 222 of the stationary support 16 can be in the form of rotational members 240 that extend through the base 222 and define the pivot rod 218 of the stationary support 16. In this configuration, operation of the lever 216 can be used to rotate the rotational member 240 of the pivot rod 218, and, in turn, the rotational member 240 of the base 222, for contemporaneously rotating each of the operable support 20 and the ladder cover 210. Additionally, rotational force 242 provided by the lever 216 can be transferred through the pivot rod 218, such as cylindrical rods, to multiple locations along the stationary support 16. This includes the pivot arm 220 that engages with the linkage 90. Through this configuration, the rotational force 242 supplied by movement of the lever 216 can be transferred and evenly distributed to multiple locations of the stationary support 16 to effectuate the contemporaneous movement of the operable support 20 and the ladder cover 210. Also, to achieve the rotational movement of the operable support 20 and the ladder cover 210, the operable support 20 and the lever 216 can be fixedly attached to the pivot rod 218. Additionally, the ladder cover 210 can be fixedly attached to the rotational member 240 of the base 222. Through these fixed connections, the rotational members 240 can operate to rotate the ladder cover 210 and the operable support 20 through movement of the lever 216.

In certain aspects of the device, the lever 216 can be engaged with the pivot rod 218 via a ratchet connection. Accordingly, the lever 216 can be rotated a certain rotational distance to supply a rotational force to the pivot rod 218, then ratcheted back a particular rotational distance while the pivot rod 218 remains stationary. The lever 216 can then be again rotated to further rotate the pivot rod 218 to operate the ladder cover 210 and the operable support 20, as described herein. The ratcheting mechanism that can engage the lever 216 with the pivot rod 218 can be reversible. In this manner, the ratcheting operation of the lever 216 can be used to operate the operable support 20 between the storage position 22 and the loading position 24, and also operate the ladder cover 210 between the covering position 98 and the bypass position 96.

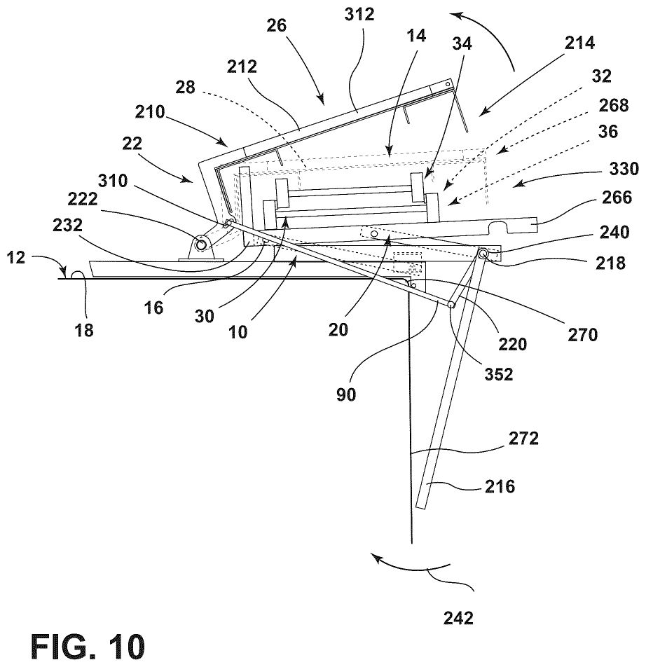

Referring again to FIGS. 10-15, the operable support 20 is rotationally operable relative to the stationary support 16 via an outer connector 260 that is attached to the pivot rod 218 and an inner connector 262 that is rotationally attached to the stationary support 16 at a connector pivot 264. Through this configuration, the outer connector 260 and the inner connector 262 provide for a compound rotational movement of the operable support 20 between the storage position 22 and the loading position 24. In particular, the loading position 24 of the operable support 20 positions a carriage 266 of the operable support 20 over a roof 18 of the vehicle 12 and within the ladder receptacle 36 defined by the ladder cover 210 in a closed position 268.

Referring again to FIGS. 10-15, as the lever 216 rotates the pivot rod 218, the outer connector 260 and the inner connector 262 laterally transition the operable support 20 in an upward and outward direction toward an edge 270 of the roof 18. At the same time, the operable support 20 rotates in a downward direction and around the edge 270 of the roof 18 of the vehicle 12. In the loading position 24, the operable support 20 is positioned at least partially below the edge 270 of the roof 18 for the vehicle 12 and along a side 272 of the vehicle 12 for convenient loading and unloading of the ladder 14 from the carriage 266 of the operable support 20. Again, the compound movement provided by the outer connector 260 and the inner connector 262 that extend between the operable support 20 and the stationary support 16 provides for this compound rotation of the operable support 20 between the storage position 22 and the loading position 24.

In certain aspects of the device, the linkage 90 can be attached to a portion of the lever 216. In such an aspect of the device, as the lever 216 rotates the pivot rod 218, the connection between the lever 216 and the linkage 90, which is distal from the pivot rod 218, provides the mechanical advantage to operate the ladder cover 210 between the covering position 98 and the bypass position 96.

Referring again to FIGS. 10-15, as the operable support 20 is moved from the storage position 22 to the loading position 24, and vice versa, the ladder cover 210 operates between the closed position 268, synonymous with the covering position 98, to an open position 290, which coincides with the bypass position 96 of the ladder cover 210. This bypass position 96 is characterized by the ladder cover 210 being distal from the stationary support 16 of the vehicular ladder rack 10. This distal positioning of the ladder cover 210 in the bypass position 96 permits the operable support 20 to move between the storage position 22 and the loading position 24. Further rotation of the pivot rod 218 to the loading position 24 can move the ladder cover 210 to a second closed position 292, which coincides with the loading position 24 of the operable support 20. In this second closed position 292, the ladder cover 210 is moved in close engagement with the roof 18 to cover the ladder receptacle 36 and to be located in a low profile position relative to the roof 18 of the vehicle 12. In this second closed position 292, the ladder 14 can be secured to the operable support 20 in the loading position 24 and the vehicle 12 can be moved short distances, such as between utility poles, without having to return the operable support 20 to the storage position 22. At the same time, the ladder cover 210 is in the lowered second closed position 292 so that the vehicle 12 is able to be moved without having the ladder protection system 26 be a vertical obstruction.

Referring again to FIGS. 10-15, to achieve this rotation of the ladder cover 210, the cover frame 212 includes a linkage portion 310 that is attached to the base 222 of the stationary support 16, and a cover portion 312 that engages with and is typically attached to the protecting member 214. The protecting member 214 can be in the form of at least one channel that covers the first side 30 and the second side 34 of the ladder 14. The protecting member 214 can also be in the form of a plurality of channels, such as an inner ladder channel 28 that provides protection to the first side 30 of the ladder 14 and an outer ladder channel 32 that provides protection to the second side 34 of the ladder 14 in the storage position 22.

Referring again to FIGS. 10-15, the storage position 22 is further defined by a retracted position 330 of the operable support 20 and the covering position 98 of the ladder cover 210. Operation of the pivot rod 218 moves the ladder cover 210 from the covering position 98 toward the bypass position 96 and the operable support 20 to a raised position 332 while the ladder cover 210 is in the bypass position 96. Further, operation of the pivot rod 218 toward the loading position 24 places the operable support 20 in the extended and lowered position 334, and the ladder cover 210 in the second closed position 292.

The linkage 90 extends between pivot arm 220 of the pivot rod 218 and a frame pivot 350 of the linkage portion 310 for the cover frame 212 of the ladder cover 210. Typically, the pivot arm 220 is fixedly attached to the pivot rod 218. Accordingly, rotation of the pivot rod 218 results in a corresponding rotation of the pivot arm 220. The linkage 90 is then rotationally attached to the pivot arm 220 via a rotational connection 352. In certain aspects of the device, the linkage 90 can be fixedly attached to the pivot arm 220. Through this configuration, each of the base 222 and the pivot rod 218 define a fulcrum to provide a mechanical advantage for operating the ladder cover 210 and the operable support 20. In particular, the lever 216 uses the pivot rod 218 as a fulcrum between the lever 216 and the pivot arm 220 for rotating the operable support 20 by rotating the pivot arm 220 of the pivot rod 218. At the same time, the lever 216 delivers rotational force 242 through the pivot rod 218 to rotate the ladder cover 210, using the base 222 as the fulcrum, and rotating the frame pivot 350 to rotate the ladder cover 210. Through this configuration, operation of the lever 216 operates both the operable support 20 of the vehicular ladder rack 10 as well as the ladder cover 210 of the ladder protection system 26.

It is contemplated that the ladder protection system 26 can include various counterweights to assist in rotation of the lever 216 about the pivot rod 218 to achieve the cooperative movement of the ladder cover 210 and the operable support 20 of the ladder rack 10. The progressive movement of the ladder protection system 26 and the operable support 20 from the storage position 22 to the loading position 24, as illustrated in FIGS. 10-15, is reversed for moving the ladder cover 210 and the operable support 20 from the loading position 24 back to the storage position 22.

According to the various aspects of the device, the inner ladder channel 28 and the outer ladder channel 32 can be made of any one of various materials. These materials can include, but not limited to, metal, plastic, various polymers, vinyl, carbon fiber, combinations thereof, and other similar generally rigid materials. Use of the ladder protection system 26 provides for a system that is incorporated within the ladder rack 10 to protect the ladder 14 during storage and transport. The ladder protection system 26 is incorporated within the ladder rack 10 so that the inner ladder channel 28 and the outer ladder channel 32 can be used passively to protect the ladder 14 and the components thereof. The ladder protection system 26 operates in cooperation with the operable support 20 of the ladder rack 10 to provide for a passive protection system that protects the ladder 14 and also provides for convenient access to the ladder 14 when the operable support 20 is in the loading position 24.

According to the various aspects of the device, the ladder protection system 26 can include a telescoping structure that can extend and retract to accommodate different sized vehicles 12 and/or different sized ladders 14. Where the ladder protection system 26 includes the inner ladder channel 28 and the outer ladder channel 32, the inner ladder channel 28 and the outer ladder channel 32 can include multiple sliding members that provide for the telescoping function of the ladder protection system 26. The telescoping function can be set during installation of the ladder protection system 26 onto the vehicle 12. In this manner, the length of the ladder protection system 26 can be set one time to accommodate the vehicle 12. It is also contemplated that the ladder protection system 26 can be intermittently adjusted in length to accommodate ladders 14 of different sizes. In this aspect of the device, the ladder protection system 26 can include a securing system that maintains the telescoping inner ladder channel 28 and outer ladder channel 32 in a desired position and configuration. It is also contemplated that the inner ladder channel 28 and the outer ladder channel 32 can be adjusted between a parallel configuration to accommodate extension ladders 14 and angled configurations to accommodate step ladders 14.

According to the various aspects of the device, the ladder protection system 26 can receive any one of various ladders 14. These ladders 14 can include, but are not limited to, extension ladders, step ladders, straight ladders, combination ladders, and other similar ladders. Typically, the ladder protection system 26 is used in connection with extension ladders and straight ladders that are made of fiberglass. The fiberglass construction of these ladders 14 is useful in use with power lines and electrical poles, where the fiberglass can act as an electrical insulator.

Using the ladder protection system 26, a ladder 14 can be stored within a ladder rack 10 of a vehicle 12 for an extended period of time without experiencing degradation due to exposure to solar radiation and other elements while stored on the ladder rack 10. The ladder protection system 26 also provides for an operable system that allows for convenient access by a user to load and unload the ladder 14 from the operable support 20 for the ladder rack 10. Use of the ladder protection system 26 can be used to extend the functional life of a ladder 14 by preventing degradation caused by exposure to elements.

It will be understood by one having ordinary skill in the art that construction of the described disclosure and other components is not limited to any specific material. Other exemplary embodiments of the disclosure disclosed herein may be formed from a wide variety of materials, unless described otherwise herein.

What is claimed is:

1. A ladder protection system for a vehicular ladder rack, the vehicular ladder rack having a stationary support that is attached to a vehicle and an operable support that is coupled with the stationary support and movable relative to the stationary support between a storage position and a loading position, the ladder protection system comprising:
a ladder cover having a cover frame and a protecting member that defines a ladder receptacle with the ladder cover in a covering position and said operable support in said storage position;
a lever that is attached to a pivot rod that is defined where the operable support rotationally engages the stationary support, the lever rotationally operable to rotate the pivot rod, and wherein rotation of the pivot rod moves the operable support between the storage position and the loading position; and
a linkage that extends between the pivot rod and a base of the ladder cover, wherein the linkage operates with the pivot rod to operate the ladder cover between the covering position that defines the ladder receptacle, and a bypass position that allows the operable support to move away from the ladder cover and to the loading position.

2. The ladder protection system of claim 1, wherein the cover frame that includes a linkage portion that rotationally attaches the linkage with the cover frame.

3. The ladder protection system of claim 2, wherein the base is fixedly attached to said stationary support, and wherein the linkage portion of the ladder cover rotates about a base pivot between the covering position and the bypass position.

4. The ladder protection system of claim 3, wherein the ladder cover further includes at least one ladder channel that defines the ladder receptacle with the ladder cover in the covering position and said operable support in said storage position.

5. The ladder protection system of claim 4, wherein the at least one ladder channel includes an inner ladder channel configured to cover a first side of the ladder receptacle and an outer ladder channel that is configured to cover a second side of the ladder receptacle in the covering position.

6. The ladder protection system of claim 5, wherein the cover frame includes the linkage portion that rotationally engages said stationary support of said vehicular ladder rack, and a cover portion that attaches to each of the inner ladder channel and the outer ladder channel.

7. The ladder protection system of claim 1, wherein the ladder cover moves to the covering position in each of said storage position and said loading position of said operable support.

8. The ladder protection system of claim 3, wherein the linkage is coupled with the pivot rod via a pivot arm, and coupled with the linkage portion of the ladder cover via a frame pivot, wherein operation of the pivot rod is transferred to the ladder cover via the pivot arm and the linkage, wherein the pivot arm is fixedly attached to the pivot rod and the linkage is rotationally coupled with the pivot arm.

9. A ladder protection system for a vehicular ladder rack, the vehicular ladder rack having a stationary support that is attached to a vehicle and an operable support that is coupled with the stationary support and movable relative to the stationary support between a storage position and a loading position, the ladder protection system comprising:
a ladder cover that is operable between a covering position and a bypass position, the covering position configured to extend over said operable support in said storage position, and the bypass position configured to be rotated away from said stationary support to permit rotation of said operable support between said storage position and said loading position;
a lever coupled with each of said operable support and the ladder cover via a pivot rod, wherein operation of the pivot rod operates said operable support between said storage position and said loading position; and
a linkage that extends between the pivot rod and a linkage portion of the ladder cover, wherein the linkage operates with the pivot rod and the linkage portion to operate the ladder cover between the covering position and the bypass position.

10. The ladder protection system of claim 9, wherein the ladder cover includes a cover frame that includes the linkage portion.

11. The ladder protection system of claim 10, wherein the ladder cover includes a base that is fixedly attached to said stationary support, and wherein the linkage portion of the ladder cover rotates about a base pivot between the covering position and the bypass position.

12. The ladder protection system of claim 11, wherein the ladder cover further includes at least one ladder channel that defines a ladder receptacle with the ladder cover in the covering position and said operable support in said storage position.

13. The ladder protection system of claim 12, wherein the at least one ladder channel includes an inner ladder channel configured to cover a first side of the ladder receptacle and an outer ladder channel that is configured to cover a second side of the ladder receptacle in the covering position.

14. The ladder protection system of claim 13, wherein the cover frame includes the base that rotationally engages the stationary support of said vehicular ladder rack, and a cover portion that attaches to each of the inner ladder channel and the outer ladder channel.

15. The ladder protection system of claim 9, wherein the ladder cover moves to the covering position in each of said storage position and said loading position of said operable support.

16. The ladder protection system of claim 11, wherein the linkage is coupled with the pivot rod via a pivot arm, and coupled with the linkage portion of the ladder cover via a frame pivot, wherein operation of the pivot rod is transferred to the ladder cover via the pivot arm and the linkage, wherein the pivot arm is fixedly attached to the pivot rod and the linkage is rotationally coupled with the pivot arm.

17. A ladder protection system for a vehicular ladder rack, the vehicular ladder rack having a stationary support that is attached to a vehicle and an operable support that is coupled with the stationary support and movable relative to the stationary support between a storage position and a loading position, the ladder protection system comprising:
a ladder cover that is operable between a covering position that defines a ladder receptacle for extending over said operable support in said storage position and a bypass position that is configured to be distal from the stationary support to permit rotation of said operable support between said storage position and said loading position; and
a linkage that is coupled with a lever and a linkage portion of the ladder cover, wherein in the event that the lever is rotated, the linkage operates with a frame pivot of the linkage portion to operate the ladder cover between the covering position and the bypass position, wherein operation of the lever is further configured to contemporaneously operate said operable support between said storage position and said loading position.

18. The ladder protection system of claim 17, wherein the lever rotationally operates a pivot rod, and where rotational operation of the pivot rod rotates a pivot arm that is attached to the linkage to operate the ladder cover between the covering position and the bypass position.

19. The ladder protection system of claim 17, wherein the ladder cover further includes at least one ladder channel that defines the ladder receptacle with the ladder cover in the covering position and said operable support in said storage position, wherein the at least one ladder channel includes an inner ladder channel configured to cover a first side of the ladder receptacle and an outer ladder channel that is configured to cover a second side of the ladder receptacle in the covering position.

20. The ladder protection system of claim 18, wherein the pivot arm is fixedly attached to the pivot rod and the linkage is pivotally attached to the pivot arm, and the linkage is coupled with the linkage portion of the ladder cover via the frame pivot, wherein operation of the pivot rod is transferred to the ladder cover via the pivot arm and the linkage, and the cover frame is rotated about a base pivot as the linkage moves the frame pivot.
